(19) United States
(12) Patent Application Publication
(10) Pub. No.: US 2002/0111133 A1
(43) Pub. Date: Aug. 15, 2002

(54) Data processing appliance

(76) Inventor: Erland Wittkotter, Buende (DE)

Correspondence Address: Dr. Erland Wittkotter, Koppelstr. 19, Buende, 32257, DE

(21) Appl. No.: 10/047,275

(22) Filed: Jan. 15, 2002

(30) Foreign Application Priority Data
Jul. 15, 1999 (DE) 199 32 703.3
Jul. 17, 2000 (EP) PCT/EP00/06824

(51) Int. Cl. H04K 3/00

(52) U.S. Cl. 455/1

(57) ABSTRACT

The invention relate to a data processing appliance with a local computer unit which correspond to a local data file system for calling and for storing and for bi-directional data transferring of a volume data file by means of a computer unit and an user identification unit, which is corresponding to the local computer unit, which enable an access on volume data files through the computer unit by an authorized user as a reaction on its positive identification only, whereby the volume data file in the local data file system is stored in a non-usable, encrypted form, which is not usable for a user, whereby a data transferring path of volume data file between the local computer unit and the local data file system comprise a corresponding key management unit as a part and functionality of the local computer unit, which generate and assign at least one user specific and volume data specific key file for each volume data file, the key management unit with a portion of the local data file system, which is connected to the logically separated key database and for linking of a key file which is stored in the key database with a volume data file which is stored in a local data file system for generating an electronic document, that is usable by an user whereby the key database is provided locally in the data processing appliance and assigned to the local data file system, but logical or structural or physical separated from a drive—or mass storage unit, which is assigned to the local data file system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

The present invention concerns a data processing appliance as set forth in the classifying portion of claim 1.

### FIELD OF THE INVENTION

Facing the background of increasingly strict requirements on the data protection, the protection against forbidden data access by third party and the unauthorized copying of entire data- and file structures resp. of the unauthorized access and insight on/in these data represent the general problem of the access protection on user files not only for mainframe computer system or on enterprise distributed networks; often single desktop systems or small, local computer cluster are in danger in a similar manner.

Therefore admission rules and access protection have been introduced in practical all computer operation systems and application programs. This cover a password protected at start-up of computer (which enable the starting up of an operation systems, only if a correct password is inserted), up to individual access protection for instance with an application program, e.g. a text processing application, which create electronic documents (whereby “electronic document” will be regarded in following as arbitrary files, usable for an user, i.e. reasonable occupied with the intended content resp. communication purpose, readable, recognizable, displayable useful and usable files, including executable programs; in a practical utilization these are for example texts, image, picture, frame, sound- and/or picture or image sequences, 3-D animations, interactive input forms etc.).

### DESCRIPTION OF THE RELATED ART

In particular in the fields of applications of a local working place or computer cluster password protected access- or start-up routines are offering usually only an insufficient protection: even when for instance with password protection of a working place computer which is regarded as an access protection offered by a computer operation system a computer can't be started by an unauthorized user, the risk exit that either by using bypasses an access can be taken on the corresponding mass data storage of these desktop computer, or more simple for instance by means of using an backup routine, the complete content of such mass data storage for example a hard disk can be read out and then be analyzed and read illegally at a later time with a different system.

In addition an individual document password protection is promising against these kind of unauthorized backups only an insufficient protection, because even password encoded files stored on hard disk can often be reconstructed in its original open version with modest effort by using and exploitation of the inherent, internal redundancy of images or language. Such a document-specific password protection, which is usually understood as user level cryptography, is limited by its strictly document dependency and is sensible on mistakes in operations, complexity and elaborations: It remains the risk, that a user forget to encrypt individual files or that he doesn't delete an original unencrypted text file after he has saved the encrypted one. Furthermore the utilization isn't really comfortable, because usually during a user session (session) a corresponding password have to be inserted in a plurality. In particular in relation with file server in a web like environment it is moreover practically unavoidable, that at least at certain times cleartext type, unencrypted user files are existing on an storage medium and by this way for example open access may be possible by network.

As a further disadvantage of such solution known in the state of the art, as they are known for example in relation with widespread text processing system, is based on the fact, that a respective user has to memorize a corresponding password. Therefore the risk of losing the document is large in particular in the case of losing the password. Furthermore a decryption is done specific to certain programs resp. applications only, therefore in particular an access on such an encrypted file with other applications and its reusing is strongly aggravate, if it is not impossible.

As already mentioned the principal disadvantage of a classical encryption that is based on known cryptographic methods (symmetric or asymmetric encryption like DES, IDEA, RSA, El-Gamal) is related to the dependence on the secrecy of a relatively short key, usually 56 resp. 128 Bit. If such a key is calculated with the use of a limited data context, because of the mentioned internal redundancy of the language or the standards, in which the regarded electronic document were generated, then the entire content, in which the key were used, can be read also.

A further problem is arising from so called open systems, which are managed by multi-user operation system and which enable access on network mass data storage. Such an access is usually managed by the operation system insufficiently, and in particular in normal situations it can't be traced back who has written or read when and from where which data. In contrast it is obvious that in particular in a confidential context such information may be necessary, for instance in the case of a later proofs or reasoning, or for an improved source protection.

### BRIEF SUMMARY OF THE INVENTION

Therefore it is the object of the present invention to improve the general kind of data processing appliance that is involved with respect to data protection of locally stored net-resp. volume data, and in particular in diminishing the threat of completely copying of mass data storage content, for instance with backups, and by unauthorized data access. Furthermore in particular the security disadvantages of known cryptographical method against decryption have to be overcome and the encryption security has to be increased.

This objective is attained by the apparatus with the features of the claims 1 and 10 and the method with the steps of the claims 7 and 8; preferred development of the invention are resulting from the related, dependent claims.

According to the invention in a preferred manner a turning away occurs in the single desktop- resp. local network domain of principal reasons provided by conventional role specific (i.e. related on user, e.g. related to administrator) passwords and in this manner a protection of security wanting of useful files—in the following and within the framework of the invention also mentioned as volume data file—take place according to the invention by the additionally appointed key management unit in relation with the key storage unit (“key file”).

More precisely an essential feature of the present invention consist that any file (resp. a selected and/or specified by the operation system), comprise—access protected—storage and appointed for a later re-calling have to be encrypted before its storage in the local data file system, which in particular can be preferably a conventional mass data storage, for example a hard disk, an optical drive etc. and particularly by means of both file- and user specific keys as well as. This means within the framework of the present invention each volume data file that has to be secured, preferred the entirety of all files that are stored in the data file system, have to be provided with an individual key, which is stored separately (in other words not in a direct assignable manner to the data file system), and a volume data file, which is openly used and usable only together with the additional, individualized key. Furthermore this means that the user specific features of a key, that different user using the data processing appliance, which is according to the invention have to pass, an respective affiliation and authorization check, in other words a user (within the framework of the invention within the term “user” also user group can be understood) can within the framework of the present invention only access on the volume data files, which are appointed resp. authorized for him, and this will in addition—different from state of the art—in particular provided by the individualized key file resp. key data records of a database.

In the practical realization of the invention before each working session with access on—as such not usable—volume data file it has to occur at least one single identification and authorization of a respective user, and foremost by linking with a separated stored resp. generated key file a preferred durable stored volume data file can be stored in the data file system resp. can be used in a usable form.

Thereby not only the main problem of present, password protected data processing system from state of the art will be solved (in addition a complete copying of a hard disk with the data file system enable no direct access to the usable useful data), by insertion of the key management unit according to the invention between the bi-directional storage- and calling path which is inserted between computer unit and local file system these securing procedures are invisible or hidden and unnoticed for an authorized user—after a single, successful identification—, furthermore offering for example the advantage, that in the course of a working session at a data processing system (session) it is not necessary in each newly opening of a text file to insert an corresponding and relevant password.

Moreover a further advantage of an user- and file specific encryption according to the invention comprise that in the case of the publication of an individual key the necessary effort for a change of key or a change of access rights or status will be relatively small.

In accordance with a development it is provided within the framework of the invention, for accessing of keys a further in form of an encrypted intermediate or interim file (intermediate layer) is realized, which is not provided on an common backup unit stored security level, which is in particular further increasing the security of the access on the key. Thereby with such an even encrypted physical remote intermediate state it is secured that the real and original key file is not directly accessible.

As result of the present invention arise, that in principal the reading of the encrypted data file system, for instance for the purpose of backup, as such offers and generally will be made accessible and in particular independently of an authorizing (because the result of such an backup is still encrypted). Accordingly such security procedures, like the backup process, will be independent of for instance a certain, secure access status (usually supervisor, super user or system administrator), because the real and actual reading right resp. the ability, to access on the electronic document in cleartext (i.e. open and unencrypted), can be offered independently of the backup function and thereby of a supervisor or like that.

According to a preferred development of the invention, for which independent protection will be claimed, additionally semantic, i.e. content- and/or meaning distorted encryption method, are used, whereby the content of volume data file to be protected will receive an accompanying unusable version and beginning with an accompanying file- and user individualized key file, which offers for example a sequence index for a correct ordering of interchanged single terms or sentences of a text, a such encrypted text can be made understandable in the combination.

Such a semantic encryption is offering in compare to classical cryptography methods, in particular in the present context, when encryption is applied on the level of file system, a plurality of advantages: In this way on one side the encryption security, in particular given by the potential, arbitrary information component inserted resp. exchanged, almost absolute, whereby in particular each context- resp. content dependency of the key of encrypted text is not available anymore. With this encryption method it also allows to establish a reference to the respective user in a simple manner. A certain original amount of data, for instance texts, allows furthermore according to a preferred development of the invention the encryption in that manner, that indeed a respective content is distorted or destroyed in compare to the original content and is changed, so that generally will be seen as useless in the view of users, nevertheless a meaning and/or a technical readability and suitability for displaying the encrypted amount of data remains (with the effect that most likely no one will be able to recognized at all that an encryption is present). Then this is for example the case, when certain words and terms of a text (which can be understood as an information component in the sense of claim 8) are replaced by semantic and/or grammatical equivalent or comparable expression, but regarding the content it is differently to understand.

Generally the present invention requires a meta language in form of a linear concatenation of meaning carrying modules (information component), which for the purpose of the present method are disassembled and by the actions of interchanging, removing, attaching and/or interchanging are transformed in a form (alignment) not usable for a user.

Within the framework of the present invention an apparatus is used for the treating of an electronic stored original amount of data, which in particular is suitable and designed for the implementation of the above described semantic encryption.

In accordance with the invention in advantageous manner the functionality of a key generation- and management unit will be realized by such an apparatus, which is able both to generate from an original document (in other words the original amount of data resp. useful file) to be protected the semantic encrypted volume data together with key data, and to provide a management and a further treatment the so generated amount of data as well as. So in particular the analyzing unit is designed according to the invention, so that within the framework of the given format structure and/or grammar of the original documents that it provide the precondition for a following regarding content- resp. meaning referring encryption, and that the encryption unit subordinated the analyzing unit possess then the core operations of the semantic encrypted, in other words the interchanging, removing, attaching and exchanging, of the information component of the original amount of data, regarding the analyzed format structure and grammar.

It is especially suitable to carry out for instance the operations of the interchanging or exchanging so that a regarded information component with resp. by content related, structural or grammatical equivalent information component can be replaced, as far as the results of the operation remain still apparently meaningful. In accordance with a development the designed equivalence unit enables within the framework of the present invention the identification resp. the selection suitable of equivalent information component for these or other operations.

According to a further, preferred development of the invention furthermore an operation occurs through the encryption unit with respect to the grammar (of the underlying natural, machine or human language), of the format or of the syntax of the original documents: By effects of the preferred designed semantic rule-applying unit, in other words according to the invention the designed encryption unit is able to generate an encryption result, so that similar to the original file it possess an accordingly grammatical, formatmäβige and/or syntactic structure, so that it is not only given equivalently with regard to the respective individual information component (e.g. words in an text), but rather with regard to the structures and/or format according alignments (also e.g. the alignment of terms in a sentence according to the rules of the grammar) it is rule-conforming and thus without verifying regarding its content it is not recognizable, that an encryption effect by causing operation on the information component has occurred. As equivalent within the framework of the present invention will be included the so-called metaphoric equivalences. As metaphoric resp. metaphorical within the framework of the present invention any elements of a language are regarded, that is standing in a reasonable meaningful connection to each other, therefore belonging in a way of a common content-related, thematic and/or meaning offering group of language elements (for instance words). Typical example for within the framework of the present invention metaphorical equivalent terms are e.g. “train station”, “gas station” or “airport”, which are belonging respectively thematically to the topic “traffic” or location and it is in this sense metaphoric exchangeable. Other examples are first names, local destinations or numerical information (like specific dates, currency information etc.), which can be regarded as metaphoric equivalently to each other also.

According to a further, preferred development the encryption unit is assigned to a controlling unit, which randomize the encryption operation (i.e. the application and effect of the single and separated encryption operation): By generating and considering of a random component, e.g. a random number generated in otherwise known manner and its consideration by carrying out of a thereof dependent number of encryption operations, it is guaranteed, that an encryption of the same original document leads always to different results, also the encryption even under otherwise identical conditions never generate the same encryption result. Also this measure allows to increase furthermore the security of the present invention.

Generally it has been proven in a particularly preferred manner, that a user applying the encryption has to be given the possibility, to pre-select a predetermined encryption level (and with that an encryption security): In the described aspect of invention the semantic encryption correlated the question of the encryption level with the number of carrying-out encryption causing basic operations of interchanging, removing, attaching or exchanging, and determines in this respect also the volume of the generated key file. By tuning of suitable parameter the user can actually determine a security level of the encryption operations to be carry out, whereby however, in contrast to the known, classical encryption methods, in which in each case the result of the semantic encryption provide a seemingly correct (i.e. seemingly unencrypted) result, and that the question, whether actually an encryption has occurred without content-related (resp. with previously knowledge provided) verification process is not possible. In this respect even a certain protection effect can be achieved by these semantic encryption for the first time in order to reach the effect of uncertainty, and this without a single encryption operation in the previously described way has been carried out before.

A further, particular preferred embodiment of the present invention has furthermore been showing, that in accordance with a development by means of the designed conversion unit the volume data are outputted as documents, while the key file is generated and can be outputted as a executable script data of a suitable structure- or script language, e.g. XML, SGML, XSL, Visual Basic (Script), JavaScript etc., with the advantage that in particular in connection with net- or Internet-based application then in particular simple manner a reconstruction of the original data can occur, in most simple case by executing the script that cause the immediate reconstruction (which is transferred over a suitable, the interest of the protection seeking considered connection or communication line), and which is providing furthermore a starting points for further security procedure, e.g. data integrity or server contacts.

In the result with the help in accordance to the infrastructure provided by the invention a high level secure and nevertheless user friendly protection architecture can be created, which do not protect only the interest of the creator of an electronic document that is worthy for protection much better than other given conventional methods, but furthermore enable potential users of the protected content a more easy and comfortable access and interaction (updates) with the document, and finally it is to be considered, that only the existence of an effective protection instrument is a guarantee against illegal copying and distribution, so that also future electronic documents of valuable content will be made available generally and with high quality.

According to a preferred development of the methods the semantic encryption is furthermore designed, according to the invention that a generated key file (amount of data) for third person or party is separately encrypted (conventional or semantic), and particular at least twofold, whereby the result of the first encryption can be assigned to a first person and the result of the following second encryption can be assigned to a second person. Then such a procedure has, according to the invention, the advantageous effect that even with a loss of the actual amount of key data the useful data file can be reconstructed, so that both receptor of the following encryption results generate that with each other that they generate the amount of key data by consecutive decryption. Such a procedure correspond to an four-eyes-principle, which in accordance to the invention would provide in an advantage manner of the present invention an independency of the original key, in other words the firstly generated amount of key data, so that this can prevent further consequences of accidences, like the loss of the original key for instance by dieing of a password holders. Accordingly an additional, double or twofold encryption of the correct key file is comprised, a first result of the additional encryption is assigned to a first third party, a second result of the additional encryption is assigned to a second third party and the correct key file will be reconstructed by following in order of encrypting with the first and the second result.

Not only in this concrete example it shows furthermore, that within the framework of the invention the so encrypted useful data file provide a volume data file, in other words—in contrast to the open content—it shows a comparable or at most slightly changed extension of data volume.

An advantageous embodiment of the present invention lies therein, that the key storage unit (key database) according to the invention can be designed locally, so within the spatial boundaries of the data processing appliance (e.g. given by an additional hard disk or others, depart of the data file system spatially separated medium, or however logical-structurally separated, for instance in form of another partition with its own disk drive identification on a common hard disk unit).

Concretely for example it is possible that the volume data (as an original and initial amount of data) can be mapped and addressed over an disk drive label or character in a similar kind of an file system and consequently can be accessed by the key database, and/or the key database can be mapped or addressed in a similar manner of an hierarchical file system and for instance be denoted by means of a disk drive label or character. Accordingly the key database is matching locally in the data processing appliance, but structural or physical separated from the local data file system to be designed or assigned to the drive- or mass storage unit, and the key database is mapped or addressed by means of an own disk drive character or label, a disk drive object (which is combined with database functionality) or like that in the kind of a file systems.

As a result the present invention this lead to a clearly increased level of data protection, in particular with regard to an otherwise modest effort for an unauthorized or illegally acting person, who is able for copying (backup) of an entire file system or portion of them. By means of the present invention it is realized that a bi-directional local encryption—and therefore also for third party foremost valuable—with data and information at the time of requests occurs resp. exist only before the storing in the data file system is done, so that the present invention can also be understood as fundamental modification of a conventional open file handling system as a protected system applying encryption and decryption in both directions (with reference to a locally assigned mass storage).

It is an essential advantage of the encryption method according to the invention that the present text also called or designated “semantic encrypted”, so that actively data in form of an arbitrary connecting or linking functions can be used for the encryption, in this respect this key represent also direct properties of the encrypted or decrypted document (e.g. sequence or gaps). On the other hand classical encryption function are used—unambiguous and concrete—to produce a relationship between keys and the document to be encoded can be regarded as passive, i.e. the encryption function resp. -operations does not enclose or provided a relationship to the document.

A further, potential usable aspect of the present invention lies therein, that in contrast to classical, known encryption method, the result of the semantic encrypted can be an electronic document, which for an observer resp. user can have on the first glance a meaningful nature. Accordingly it is valid for the decryption, that within the results principally every encryption or decryption procedure can lead seemingly to a reasonable result (on the other hand the result is for instance with traditional cryptography method unambiguous, if a successful decryption has occurred, because only then a seemingly reasonable and visible result occurs). This apply in particular in the case of an application of the invention, where the key management unit for generating and assigning a plurality of user specific and volume data specific key files which is formed or created for each volume data file, whereby the key management unit as a part of the local data file system is connected to these logical separated designed key database and which is used for linking of a key file stored in the key database with volume data that is comprised in the local data file system, so that in the case of the use of a correct plurality of generated and assigned key files the correct electronic document will be generated, and in the case of the use of a non-correct of the stored key files an electronic document will be generated for a user that is only seemingly correct.

Therewith the semantic encryption lead to a potentially increased security in dealing and interacting with encrypted or decrypted documents, whereby additionally the requirement occurs, that for instance a user has to be shown after a successfully carried-out of the decryption process, that he has really and actually displayed the open, correctly decrypted result, and not for instance a (because a part of an encryption procedure remains unsuccessfully) still encrypted document.

Such a display can for instance be reached by an additional quality signal, for example in the form of concretely optical hints known in its consequences and meaning (only) by one the correctly identified user and or owner

In accordance with a development an additional quality obtain within the framework of the present invention by using semantic encryption that is according to the invention not only linked to operations like interchanging, removing, attaching or exchanging manipulated information component, that can be used for the encrypting purposes, but also an encryption effect can additionally be achieved that the currently considered information presented by semantic encryption are generated an amount of key data about the interchanged, removed, attached and/or exchanged information component, so that even this data will undergo operation for interchanging or exchanging. With other words the development of the semantic encryption lies in the semantic encryption of the respective document underlying linguistic/textual/structural meta level (which can be understood as a way for describing an electronic document). In the concrete realization this would for example be information (e.g. commands or syntax element), which describe the semantic encryption process, whereby further information will be replaced by other, preferred non-speaking or not-talking ones (with the consequence that before a concrete decryption occur such an amount of key data would have to be reconstructed again).

A concrete example of such a meta language, which is as well able to be encrypted, in accordance within the framework of the invention, are called TAG-elements, like for instance formatting instructions for table or like that. Also such format- and/or structure elements of a document, that exist in a way of a super ordinate manner over the actually content which is comprising words or sentences, are for treatable and therefore defendable within the framework of the present invention given by basic operations like interchanging, removing, attaching or exchanging.

### BRIEF DESCRIPTION OF THE SEVERAL VIEWS OF THE DRAWING(S)

Further advantages, features and details of the invention will be apparent from the following description of preferred embodiment and with references to the drawings; these are showing in:

FIG. 1: a schematically block diagram of the data processing appliance according to a first preferred embodiment of the invention and

FIG. 2: a schematically block diagram of a key generation- and management unit within the framework of the invention.

### DETAILED DESCRIPTION OF THE INVENTION

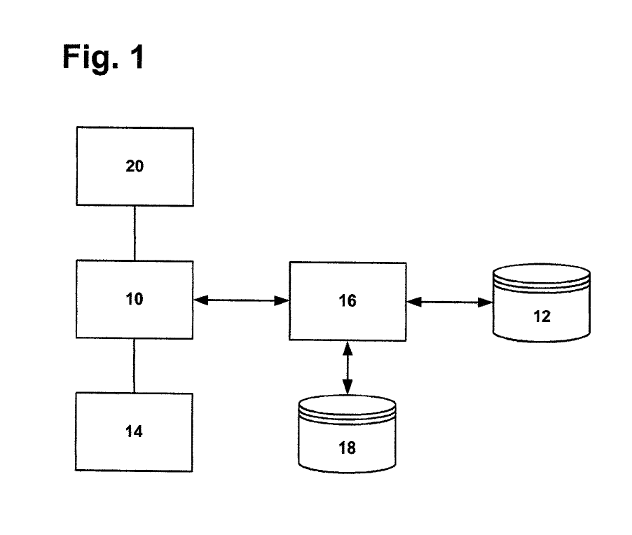

FIG. 1 illustrate in view of a single desktop computer system, how the present invention can be realized with assemblies and components of a standard PC.

A local computer unit 10 which is realized by the PC mainboard with conventional processor-, storage- and interface unit, is using a local data file system 12, which is realized as a hard disk, whereby the connection or communication between computer unit and data file system is implemented in a bi-directional manner, this means both writing procedures of the computer unit on the file system and, oppositely reading (calling or starting) files from the unit 12 as well are possible making it available, that it is open readable resp. usable over a suitable input-/output unit 14 (e.g. a monitor, printer, interface for connecting other computer system, data lines etc.).

The data file system 12 can be regarded as a logical-structural separated data file system, which is as part or portion of a larger data file system, which is appointed for the present purpose specially.

As shown in FIG. 1, between computer unit 10 and data file system 12 a key management unit 16 is interposed, which is designed to bi-directionally encrypt in direction to the local data file system 12 with useful data files—text files, image files etc.—which have to be stored, and in the opposite direction it comprise a decryption of volume data files, stored in the local data file system, in usable useful data files but which are not as such readable (i.e. not usable).

For this purpose the key management unit is using single keys, which are generated user- (group-) specific and file specific and which are stored in a key storage unit 18.

In the described embodiment the key storage unit is stored physically on the same hard disk like the data file system 12, but however logical and structural separated from them, while the key storage unit 18 (alternatively or additionally on the data file system 12) is assigned to a characteristic drive name or drive label.

Foremost by means of the document-specific keys it is possible for an user of the computer unit to output a volume data stored in system 12 in an usable (readable) manner resp. to store a currently processed file therein.

Furthermore the embodiment of the invention shown in FIG. 1 comprise a computer unit, that is connected with an available user identification unit, which for example can be realized within the framework of computer operation system or a concrete application program by an appropriate software component.

This kind of user identification is able to assign key files which are stored in the key storage unit 18 for users specifically and making it available, so that on this way a respective user has only access on volume data files in the data file system 12, which are authorized for him. In particular in a suitable example in the illustrated embodiment the drive appointed to the key storage unit include a —for the user not visible - separation with respect to users for each respective key files, so that in addition the security of the access on the data file system could be increased.

Beside known encryption method applied to volume data, which are stored unreadable (and therefore unusable as such) in data file system for the realization of the present invention in particular the so called semantic encryption is available, which offer the programmatic changing of the content of volume data file by for instance rearranging of the sequence of content components of a content that is meaningful and (completely) usable only in a given sequence (in other words for instance a rearranging of words or sentences within an entire text), whereby the generated key stored in the key storage unit 18 contain a correct sequence information afterwards. Other possibilities of such a semantic encryption would be the exchanging, removing or attaching of predetermined or randomly selected keywords, and the generating of gaps or the inserting of meaning distorted additives.

Therefore in the described manner an unauthorized access on the data file system would for instance use in the approach of taking a complete backup, the attacker will let be alone with merely incompletely and in this result useless data, which even with common decryption and cryptoanalytical method, without the separated stored key data information, anyone is able to reconstruct the data in a readable or usable form.

By the effect of the key management that is acting in the background (after one successful identification of the user by the unit 20) these security increasing procedures remain hidden and unobserved by the user, and in particular if—for instance by using specially adapted hardware components and assemblies for the key management unit 16—the encryption- and decryption steps are performing fast enough, so that the action according to the invention doesn't effect with respect to the concrete processing speed of the data processing system in a disadvantage manner. Within the framework of the present invention it is favorable to modify the one-to-one-relation between volume data file and key file in a manner, that in particular for a (e.g. extensive) volume data file a plurality of key files is assigned to, whereby in this case the term “volume data specific” has to be interpreted with respect to respective portion of file resp. portion for a related or relevant key file.

In the following it should be described, according to the embodiment given in FIG. 1, in which manner an—authorized or unauthorized—user is able to receive access to a file system, so that the way and manner of receiving access is a part and portion of the security structure within the present invention.

The essential task of the key management unit 16 is to establish a logical relationship between volume data 12 and (user- and document specific) key data 18 respectively. Thereby in a preferred embodiment of the invention it is allowed in particular to treat and to regard the combination of key management unit 16 and key storage unit 18 as a special technical representation form, which can be solved with programs, which can be realized similar to the explorer in the window operation system, and which are able to set preferences individually (i.e. user specific, and depending on the respective authorizing) and are able to display a electronic document in a hierarchical arrangement, like it is matched with respect to file ordering or file hierarchy and with respect to the respective access right of the user. In other words by effect of the unit 16 the user get displayed views or preferences (and this means it get access) to a hierarchical alignment or arrangement of documents which are authorized for him, in most favorable conditions so that he is not recognizing the fact of encryption of the respective displayed document (resp. its non-encryption). Within this individual user specific, and its specified preferences, views and arrangements given by authorization procedures, he can also act, as no protection procedure would exist visibly

Nevertheless such a view of users circumstances of working (which are still comfortable) according to the present invention are based on a higher secure assignment and document- resp. key management, like they are in the actual and original object of the unit 16: with the help of a typically database system, in the simplest case a concordance table, where different persons are assigned to respective authorized volume data files, key files, respective attribute etc., and in this way the unit 16 which contains the output or displaying unit is able to create individually the user specific preference and views and within the framework of these user specific preference it is able to encrypt document with corresponding key files so that they are correctly combined and in this way also reconstructed. Such a database system (example: table) determined by the function of the unit 16 contains regarding this typically corresponding path information the corresponding key-, volume data files; extended and/or alternatively the reconstruction instruction can in particular be contained as part or portion of key files directly in access of such a table (which is then in particular offering, if such a table is dynamically generated and which will receive advantages thereby, that the entire file system is not loaded or burdened additionally). Furthermore the “key file” can be understood within the framework of the present invention in particular as an entry in such a database (table), so that these entry enable a properly reconstruction within the framework of the invention. As well these formulation provide possibilities for additional user intervention resp. starting points for the preferred applied protection method of the semantic encryption: Not only structure, field or record content and/or sequence position of a record within the database (table) semantically can be manipulated, also the change in the arrangement of intermediate table (for instance in form of so called N:M-relation) is possible, in order to increase complexity and decryption security of the apparatus thereby. For a further increasing of security it is moreover possible, that analog to the idea of the plurality of key files assigned to a volume document, that is working with a plurality of (suitable preferable equivalent) concordance table and with the object of the volume data file, key- and user assignment, a plurality of possible views resp. release of working domains or file system portions (for each person or for several persons) can be enabled.

Part or portion of the user specific preferences or view and thereby provided working environment is managed by the file system, so that the abilities or potential for an adjustment or adaption, updating resp. an updates of a changed content is given by an interaction of the user according to the changed content of a respective electronic document, and according to the extrapolation of the encryption procedure between volume data file (in unit 12) and key file (in unit 18), so that the document part and/or it's changes by adding and supplementing, provided by the user contains an encryption accordingly. Therefore within the framework of the present embodiment synchronization procedure can be created or realized.

Then on this way it is also possible to intercept an improper or incorrect attempts of accesses on the data processing appliance within the present invention: For instance an improper or incorrect access to the authorized data inventory or database for a person can occur (which is recognized by e.g. an incorrect accessing person, that is indeed trying to authorize for a person, but he enter a wrong password), so these accessing person obtain and got displayed indeed by effect of the key management unit 16 a certain view on files, however he is neither able to access on the actual, complete content of these files, nor he is able to make sustainable changes on these data content. Rather the system is provided in a way, that it react or reply on an input of the accessing person, so thus accordingly changes on the displayed result also would not change the protected original data in accordance with the inventions, but only in the virtual view of the illegally accessing person managed by the unit 16. In this way encrypted volume data can indeed be changed by interfering of an illegally accessing person (thus an according adaption or adjustment of the key data occurs), nevertheless the underlying, original document remains unchanged by these manipulations.

In the above described manner the key database resp. the key management unit as part of the data processing appliance according to the invention represent the logical and therefore virtual, hierarchical order and create individual—user specific preferences or views (and therefore user access domains on the local computer unit), so that however this would guarantee in an equal manner a maximum of access protection against improper or incorrect access, so that in particular with the instrument and mechanism of semantic encryption, an actual connection between key files (with reconstruction instructions) and an underlying volume data file will keep invisible and intransparent.

In the practical realization of the present invention it seems in particular to be advisable, that the extensive operations of the operation system regarding operations for file access can be adapted according to the invention, but not just because to ensure a regular and methodic distinction in accordance with the invention and furthermore to ensure that an otherwise open, free accessible files of an more typical and for different applications can be used on a local computer system, but this without the appearing of security gap (or in which encrypted volume data are incorrectly misinterpreted by the authorized person that believe that he is accessing an correctly unencrypted original data file, which can happen because of the nature of semantic encryption.). Because such an interaction with an operation system could be problematic, therefore it would alternatively be possible, that within the framework of the present invention this files could be supplied with a header, in which an inspection or verification process is obligatively and automatically initiated, in order to determine whether a file has to be encrypted resp. within the framework of the present invention has to be treaded, or whether this file have left to be unencrypted because of principal reasons.

According to a further possible development of the present invention, which is based on the fact that the means of the database- and system design of the present data processing appliance blurs the border or frontier between users, that is showing individually resp. selectively (and interacting with) an electronic documents and such documents, which does not have any access rules (also the views on the directory and the document which are contained therein are not separated) and therefore uncertainty occur, whether whatsoever are the user specific preferences or views within the access protection of the electronic document.

In addition a further advantageous development of the present invention in accordance with the described embodiment it is based on the use of user specific preference or view on files in the dynamical file system and in particular in connection with a respective beginning of an user session of an user which is just generated, so that a stable, invariables scheme of user specific preference or view could not exist (accordingly this is not controllable by a controlling- resp. supervisor level, and that this explicitly should completely be separated), and that in this way the security character of the total solution can furthermore be improved.

For the additional explanations of the encryption method according to independent claim 8 (in following called “semantic decryption”), the following details and properties of this method will be explained more closely, which are the object of the present invention.

The semantic encryption, in other words the encryption of the meaning, comprises the separation of original data (OD) in volume data (VD) and operation instruction or reconstruction instructions (RI). It is forming the basic of the concept of the method that the volume data can freely distributed without additional protection. The RI has to be stored apart from the VD in a separate manner. The use of the OD and the access on the OD is only possible if the access on the RI is assigned with regulations (e.g. document right management, DRM) and correspondingly the RI are stored in a protected manner and on these RI could only be taken access in a regulated manner.

The management of the RI resp. the key data and the access to these RI occur by a database, which are called key database or key unit in the following. Because the access on these central key unit occur with a key and/or with a password also and because these data are distinctively sensible and therefore the primary goal of attacks on the confidentiality and on the secrecy of the data stored therein, the security against unauthorized access have to be secured with additional encryption.

This key unit enables the storing of the access data or admission data (AD) and thereby offering the access on the data within the framework of an access control management (DRM).

In case of an access a user, in other word a subject, is accessing on an OD object. If at all rights for the intended access operations exist, is decided by the access control management.

The access control management decides, if the requested RI for an identified subject may be released, or if the transfer of the RI to this subject has to be blocked.

Therefore the access protection on the document consist of semantic encryption applied on documents stored on a mass storage and of a classical or semantic encrypted access on the RI, which belong to the semantic encrypted VD.

The data in the key unit could be stored in a backup also. The access on the data within this key unit can additionally be aggravated, if the key that is used to take access on the key server is not unique or unambiguous. If more than one key for the decryption is plausible or even theoretically possible, a further additional criteria is necessary, in order to convince oneself and others, that the key is really correct.

The disadvantage of classical cryptography consist of the natural redundancy of the language that can be used for calculating the key, or that the keys if it exit can simply be used for proving that it is correct by a single application. The proof or evidence that the provided and used encryption key is unique can simply be given by statistical method on a large amount of data. As larger the amount of data the more easy and reliable is the decryption.

In addition the advantage of semantic encryption consist in particular on the property that large amounts of data can be protected reliably and securely. The semantic encryption provides a very large set of possible keys, which applied to a volume data, would offer meaningful and possibly useful data too. In addition a nonprofessional attacker could invent an entire class of keys by him, which applies on the encrypted data would seemingly give a correct content. The proof and evidence of originality can be done possibly later and independently of the encryption—and decryption also.

As an example the following sentence can be used: Please pick up Mr. Manfred Schmidt tomorrow (date) at 12:17 from the train station in Munich. Although the location, the time and the action are specified precisely, by using a semantic encryption no testimony can be given, what the original content really are. Everyone is able to develop and provide reconstruction instructions, which are able to change the meaning of these sentences. In this way the date, the time, the location, the names of persons or the action can e.g. be changed by the word “don't” just in front of the words “pick up” in the completely opposite.

The proof of the originality can e.g. consist therein, that between the creator and the user of these encrypted data a criteria can be committed, which both would accept as a proof of and evidence for its originality. Differently as in the classical cryptography these criteria can be of non-mathematical and/or non-statistical manner. If the creator and user is the same person, the signaling and indication of the correct decryption can e.g. be done in the displaying of an image, which correctness is known only by him. An attacker would in the same manner see also images, but he could not know which one is a correct and relevant one.

A mathematical criteria like a digital signature managed in the key unit could be applied on a portion of the data, which is non-obvious in the context, so that the reliability of the total system can be increased for the user, without offering information derived in an attack on the key.

The advantage of a database model and encryption based access control management consist in the establishing of data security, in the offering of verification procedures, whether access has been done on the data, in the tracing backward and in the inspection or verification of the responsibility, whether an access were allowed to be taken and whether a change on the data were allowed to be done. Moreover the life cycle of a document, i.e. the publishing of a document as well as the preventing of making a document accessible to others can be created and realized by an access protection on the RI.

The access on the backup data can also occur with the stored and enclosed key unit. The key data could be managed in a way, that reading of these data and managing in another key unit can be prevented. With the compare of the stored relative or absolute data positions within the mass storage unit the key unit can recognize within the access control management of the key unit, whether the access occur on a backup or on the original key unit.

With the access control management different level of secrecy can be realized. Because the document can be seen more or less independent from the kind of used semantic encryption as equivalently protected the secrecy of data and its access can be arranged by the key unit. By the belonging to an intersection of user groups a participant can be enabled to use an additional key, which can be contained in a database, so that the decrypted access on the document specific and user group specific encrypted data is released.

The use of the semantic encryption in the transferring security within the framework of a communication process consists in the exchange of encrypted data between at least 2 participants A and B. The protection of an backup or of a long term prepared archive is from the perspective of duration a transferring procedure that is regarded as an extreme example for the application of the transferring security, because by thieving of the backup all non-protected data are known to a non-authorize participant. In the case of transferring of data it has to be distinguished between a synchronic use of data at the participant B and a later therefore asynchrony (partially) use of transferred data. In the case of backup it has to be treated as an asynchrony use of data, which has to stored in a manner, that an access on the encrypted data could be done at any time and also in a plurality without knowledge of participant A.

For the establishing of transferring security it has to be given at least one contact between A and B in order to provide an identification and authentification (I&A) process. The transfer of the VD happens in one or several data transferring steps. The transfer of the RI can happen before/after/during the I&A and/or in the transfer of the VD. Within the framework of the invention the uniqueness or the plurality of transfers of RI can be fit to the transferring security and its accompanying situation. The key unit stored on the backup is managing the access on the backup by the access control management also.

If the application does not accept any time delay of data communication the transfer of VD and RI have to be temporally correlated accordingly. If the application is working asynchrony with the transfer of OD, the transfer of the RI can also occur in a non-correlated manner and possibly the VD can also carry an additional semantic or classical encryption.

Concerning transferring security this can generally be regarded as the protection of the confidentiality or the protection against changes during the transfer of data. For the semantic encryption the protection of confidentiality of VD is given immediately. The application of additional classical encryption is restricted on a small number of data, e.g. on individually encrypted RI, provided in a session manner.

The unnoticed or undetected change of the released decrypted data can with the change of VD only happen below a resolution, which cannot be noticed or detected by an attacker, if e.g. the reconstruction would consist only in the rearrangement of the correct sequence of the sentence. Since e.g. the semantic encryption can consist only in the rearranging of the sequence of sentence, the rearranging of words within a sentence cannot be determined. For the registration of changes the impression is not sufficient. Therefore an additional method for digital securing of evidence for the verification of changes can be inserted in the volume data and combined with the semantic encryption.

Since the volume data can be compressed in the communication only entirely or as a partial set of used data, the transfer of the data can occur faster and more reliable. The security of the transferred data is yielded from the non-linear connections between the compressed data. Whereby the already downloaded compressed files on the local computer can be changed in the above described manner, so that for preventing of these manipulation also classical methods of securing the evidence can find its application.

For the securing of evidences it is primary, that the data are genuine, i.e. in the sense of original, unchanged or complete. The data are of a certain (anonym or known) user, they are derived of a certain source, and resp. they are created on a certain date. For the securing of evidence the context of the data has to be presented and has to be observed. For the context also access data could belong to them. For the securing of evidence it has to be traced back, that the volume data, the RI and the database, where the access data are stored, were not changed resp. were not changed without leaving indications for changes.

So far the securing of evidence could only be established with one of the following means: storing of the values of an one way function, i.e. use of a digital signature or the storing of the data on a non changeable once writing storage medium (Laserdisc, WORM) used to store the elements (VD, RI, AD and data storage appliance) to be protected. As an additional advantage of the semantic encryption the separation of the OD in VD and RI effect as an additional improvement of the security of existing method for securing of evidences. The securing of evidence is within the framework of the semantic encryption an independent add-on, on which depending on the application it could also be renounced and which can also be regarded as a part of the key unit, in which each additional encryption can be added relatively to the existing data context.

Because the positioning of the data can be changed relatively to a set of changeable orientation—tags or -labels within a data context, beside the decryption of the data the log protocol of changes is containing relative update data, which can be stored semantically, encrypted also. A manipulation in the stored history of these data could immediately be recognized because the context either of the entire file or of a subset of data would be destroyed.

The advantage of semantic encryption consist of the fact, that there is no inherent integrity protection and that this feature can be created by additional method based on redundancy or on other context forming information that can be additional introduced.

The verification of data integrity, this means the verification of changes of data, which could either be manipulated on the source (Server), during the transfer or on the local computer, is important for the confidentiality of the semantic encrypted data. The data integrity is important for the acknowledgement of data by the user. For this purpose a mathematical method of securing the evidence like the application of an one-way function can together with a local file or an unchangeable feature on a server be inserted in a corresponding verification procedure.

In an inspection or verification of the data integrity either this inspection or verification will occur on the local machine or on the server, it all depends on how the interests are distributed in these inspection or verification process. At any time a change of data can be detected by the mathematical methods of securing the evidence, whereby this can also be done immediately before the use by the user.

A semantic inspection or verification of the data integrity can be provided flexible by a meta language, in which the semantic encryption and decryption is flexibly react by a minimal change of meta language which is drastically responding in its reconstructed results, so that the correctness of the key can recognized with the contemplation of the reconstructed data relatively easy by impression.

For the securing of evidence and data integrity the authenticity is important and not so much the secrecy of the inspected data. The secrecy yields from the additional encryption of the data. Whether the data integrity has to be inspected before or after the encryption is resulting from the concrete application.

In the key management it has to be distinguished between the key as password for identification and authentification, in the following called password, and the key as a reconstruction instruction for decrypting an electronic document. The key could also contain instructions, which on the other hand could initiate complex encryption operation and which could transform or convert in a set or amount of keys.

The key could be used temporarily only for a single communication or for a set or an amount of communication steps, e.g. for an user session. The storing of the RI in the database can be encrypted additionally. The use of keys (in the following called RI-key) will be employed in a formation of set or amount of data within the so encrypted data. Then with one RI-key could encrypt for example all RI of a document or all RI for a chapter with all contained version changes.

Always an original data source will be encrypted, which will be building up with a defined vocabulary. All languages, in particular the natural human languages, consist of an amount and quantity of words, which could be listed in a lexicon, glossary or dictionary. The application within the framework of context dependent or related sentences can still consist of words to be conjugated and decimated.

The utilization of wrong grammatical forms is within the written and verbal language normal and will usually be interpreted by humans correctly as far as it is not distinctly above a stimulation threshold and or too misapprehension, too unclear or contains a too large disagreement with the context and will not lead to meaning marking or disguising irritations.

The encryption of a backup has an additional problem, which has in a data transferring process no equivalent meaning and consequence. Because backup tapes and possible its illegal produced copy can be archived for a very long period of time, so that on one side the problem of access on password exist, that has to be remembered and used after several years again, and on the other side consist the problem, that the lost of disguising of the password has extensive consequences for the data protection. If the passwords are too difficult to remember, then the risk of forgetting arise. If in contrast to this the passwords of the creator of the backup or of an user, whose data will be stored are very easy to remember, then classical encryption method provide no protection anymore. Therefore a semantic encryption of the key unit would offer no hints, advices or evidences that the simple key is actually the correct and proper key.

The use of a local key unit save the user to implement extensive measures against failures, e.g. in the event that the key server crashes. The flexible distribution of the keys enable an online access to an external possibly centrally managed key server, just in case to establish an additional alignment for getting the topicality.

A further advance consists in the encounter of the danger that someone can penetrate a centralized database and that the knowledge of all keys can lead to a correspondingly large damage. Furthermore it exist the problem that in a possible overload by too many requests on a centralized database this can lead to problems regarding its efficient economical exploitation of this resources.

In a key distribution it has to be considered, whether the key has to be obtained or fetched or has to be delivered in encrypted manner, or whether it is already available by the local password. Furthermore it can be distinguished, whether the key resp. the passwords are inserted in the key unit in cleartext or if it have to be requested from the key unit for inspection or verification reasons. The RI-key could be stored centralized, locally or stored decentralized in a distributed manner. The manner of the key distribution results from whether the key is symmetric or asymmetric and whether the key should be used only once and therefore has to be obtained or fetched always and newly again. Furthermore the problem of key distribution arises from the necessity for changing and for the periodic change of key and passwords.

A further advantage of the semantic encryption consist in a change of the key so that no reliable information can be made, whether this process is done by changing the complete encryption, or whether it is made by a deliberately changing via updating the data inventory or database. The difference consists therein, that in a classical encryption and by knowledge of the decrypted text (clear or plain text) the new key can be exposed or disclosed also. The risk of a clear or plain text attack does not exist in the semantic encryption, because for such a discovered key no evidence exist, that this key is the correct one and furthermore an exceeding loss in confidentiality would be combined with this.

The security of the conventional password management arises on one hand from the used one-way function and on the other hand from the selection of the passwords by the user. The requirement of a length and a selection from a large character set improves the quality of a password. In order to aggravate the guessing of passwords exclusion lists could be formed. The password management is similar to a key management. In contrast to RI-key the passwords are usually determined by users. In addition they can be changed by entering or if this is required.

In order to aggravate the access on the backup the release of the key unit can be taken from the backup. It would operate only correct, if an additional information from a reliable and trustworthy computer have been verified, which imply that appropriate information were collected or gathered for these purpose only, but the release of answers imply to overcoming a plurality of single steps and maybe barriers of organizational manner also.

The key unit represents due to the important meaning and consequence for the security of the data within the total solution an important target for attacks. If a user provides his password in the identification process of the key unit, then the security of the total system may in danger thereby. Because of this reason the password input has to be protected against so called Trojan horses, which lead the user to believe that in situation where he believe to interact with the key unit, he is actually interacting with a program, which should only encourage the user to provide the password. This spying of the password is also called spoofing. The key unit can also be supplied in an embodiment with additional methods for preventing the spoofing, e.g. by generating of a plurality of access passwords for each user (with the advantage that only one is correct), so that an uncertainty components arise in the attempt of a person trying to receive access without authorization.

The access control management on a backup can also be realized as a copy protection method.

In the symmetric encryption one can immediately conclude from the key for encryption on the key for decryption. In this meaning the interchanging and exchanging of data can be regarded as symmetric encryption method. With the operation instructions for decryption one can immediately derive the accordingly decryption- RI. In the same way it is also known after the decryption occur, how the encryption has been implemented. For separating these both processes more clearly or strongly a semantic intermediate layer has to be introduced.

The instructions for interchanging or deleting etc. consist of a vocabulary or at least of tokens, to which a defined task is assigned. The vocabulary will be linked with an action by the interpretation of the reconstructions unit. The interpretation of this vocabulary can be realized by the implementation of executing operations with a meta language. If the assignment between the vocabularies to operations can be changed by a meta language, an additional key can be used in order to interpret the operations of the first key more complex. These additional keys can then be attached or supplemented either by the sender resp. transmitter or the receiver resp. receptor of the RI. The additional assignment between vocabulary and operations can interact functionally with each other, so that a calculation back to one key on the other one fails because of the complexity and unambiguity of the problem. For supporting of these processes a one-way function can be used.

From these relationship the semantic encryption can also be constituted in this way so that on this basic asymmetric encryption all state of the art known application can be enabled.

Message digits (MD) result from the application of one-way functions. A given class of entities can do the application by the semantic encryption or it will be limited to its complementary set. In this way several independent parts of message digits could be generated, which provide a protection against random and intended changes resp. Because MD are applied on the byte level and therefore a very large amount of data are relatively CPU time consuming in calculating, a semantic MD on the semantic level can be used, to detect whether a change of the volume data or of the key data or of the key unit has occurred.

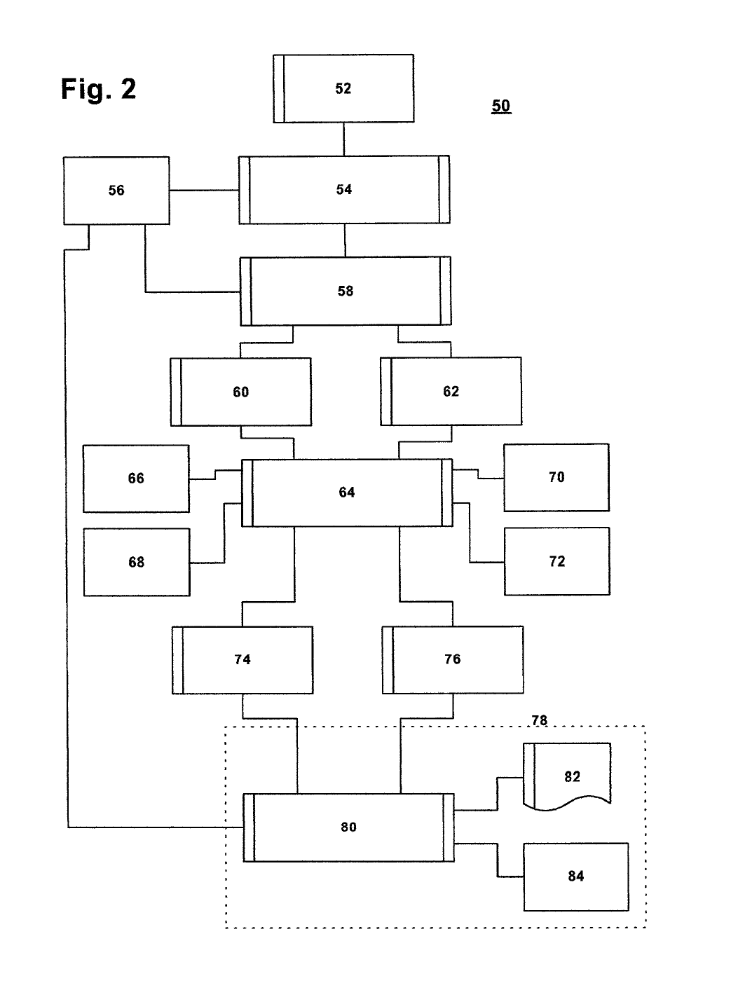

With reference to the FIG. 2 a practical embodiment of the infrastructure for the semantic encryption will be described in the following relevant aspects of the present invention.

FIG. 2 shows in a schematic block diagram a representation of the structure of the key generation- and management unit with the corresponding function components with respect to the framework of the present invention, which can be used according to the invention so that the technology of semantic encryption can be applied to transfer, to translate or to encrypt electronic documents which have to be protected into protected volume data and corresponding key files. Thereby in connection with FIG. 2 the embodiment illustrate in particular, but not merely, how to generate one (leading to the reconstruction of the original, correct amount of data) amount of key data, rather a plurality of an amount of key data, so that by these aspect the existing of a plurality of possible keys (from which only one correspond to the content-related correct one, and which will not only lead to the seemingly correct results) the security of the present invention can further be increased.

FIG. 2 should describe together with an example of an electronic text document, which is given in a conventional format (e.g. Microsoft Word) and which was generated with an appropriate text editor. The text document consisting of the sentence

Peter goes at 20.00 o'clock to the train station. The train is on time.

is stored in a storage unit 52 according to FIG. 2 and should described in the following manner by effect of the one shown in FIG. 2, who further function components will be semantically encrypt.

A read-/access unit 54 that is subordinated to the document storage unit 52, which cooperates with a format data unit 56, determine that the above document stored in the storage unit 52 provide a format structure like MS-Word (ideally the format data unit 56 contains all format- resp. structural information of all usual data formats), and capture with these (file specific) format information the text document provided by the document storage unit 52. The analyzing unit 58 that is subordinated to the read-/access unit 54 is able to analyze, evaluate and to appraise on the basic of the document information, that is read from the read unit 54 these documents, whereby the analyzing unit 58 is separating or decomposing the electronic document in its single separated information component and is storing these information in an information component storage unit 60 (in the present example this would be single word), and additionally the document structures would be recognized as a structure of two sentences limited by dots or marks and this document structure is stored in a separate structure unit 62. Therefore the content of the unit 62 contains the character of a document specific meta file, on which also later encryption procedure can have access to (even only selectively).

Concretely the content of the document structure storage unit can be regarded after the analysis of the original document have been applied by the analyzing unit as following:

sentence 1 (1, 2, 3, 4) sentence 2 (1, 2, 3),

while the information component storage unit 60 of this structural analysis have corresponding information component. Therefore it contains words:

(1.1) Peter
(1.2) goes
(1.3) at 20.00 o'clock
(1.4) to the train station
(2.1) The train
(2.2) is
(2.3) on time

With this following activity an important preparation for the encryption operation it is now possible to implement on both the single information component (in present example the single words), and on the sequence of information component resp. structure of basic operations of the semantic encryption as well, in other words the interchanging, removing, attaching or exchanging. An essential protection effect of the semantic encryption according to the invention is based on these operations that will not arbitrary occurs, but these will occur under retention or preservation of the grammatical, syntactical and/or format rules, so that as a consequence of the encryption a result occur, which seems to be correct (i.e. without content-related verification), with other words, one would not recognize, that in fact it is just an encrypted result.

In the present embodiment with help of the encryption unit the above given electronic document will be the following text:

Thomas comes at 16.00 o'clock from the cemetery. The train is on time.

Without knowledge of the real or true content these sentence appears also like an open, unencrypted result, so that an essential, protection providing effect of the present invention is already based on the risk, that an attacker facing these text may not achieve the impression and is facing the uncertainty that this text is encrypted, and refrain from the beginning to start an attack on these text.

Concrete in present embodiment the following occur by effect of an equivalence unit 70 (which can be regarded in its most simplest version as a table resp. database of equivalent, i.e. corresponding and interchangeable or exchangeable terms): The content component “Peter” of the original document would be replaced by the grammatical equivalent content component “Thomas”, whereby structure of sentence and grammar were retained, but however the meaning of the original document is already destroyed. Accordingly the content component “goes” of the original document in the equivalent component “comes” would be changed, the content component “at 20.00 o'clock” would be replaced by “at 16.00 o'clock” (here it was determined by effect of the equivalence unit, that it is a numerical date in a time format, so that a manipulation within the permissible time range will be possible), and the content component “to the train station” will be replaced by the content component “from the cemetery”. Furthermore with a semantic rule-applying unit 72 which is in combination and influencing the encryption unit 64 the encryption result “. . . comes . . . from the cemetery” guarantees that it is grammatical and syntactically correct, and therefore could not been identified as manipulated. By means of the encryption unit 64 and the equivalence unit 70 resp. semantic rule-applying unit 72, which are working together it could be determined that the content component “the train” of the following sentences provide an content-related reference to the previous sentence, in which the newly inserted content component “cemetery” is introduced, so that even without an encryption of the second sentence a completely different meaning occurs (and therefore an encryption effect).

As result of these described, simple encryption operations the encryption result will be “Thomas comes at 16.00 o'clock from the cemetery. The train is on time.”

and outputted as volume data and will be stored in a volume data storage unit, while a reconstructing enabling key (in the present embodiment an information about the respective interchanged words within its position in the sentence and in its respective content-related terms) is stored in a key data storage unit 74. Accordingly the relevant key file for the storage unit 74 can be considered as follows (in the following example the command EXCHANGE will be interpreted by the reconstruction unit in order to carry out the interchanging with the argument):

EXCHANGE (1.1; Thomas)

EXCHANGE (1.2; comes)

etc.

In a development of these embodiment the vocabulary of the command language is even dynamically and can be changed by functions of a script language; the command EXCHANGE would be replaced by some other, arbitrary expression.

According to a further preferred embodiment of the invention a plurality of key files to be generated, is designed from which only one generate the correct reconstruction result. Key file 2 could begin correspondingly as follows:

EXCHANGE (1.1; Richard) (Remainder as in the above key file);

key file 3 start with:

EXCHANGE (1.1; Claus)

etc.

In embodiment of FIG. 2 additionally to these both storage units also an output unit 78 is subordinated, which in particular process in a simple manner the key data 74 in form of a script that can be outputted as an executable script file 84; this occur with the help of a conversion unit 80, which in otherwise known manner are generated from the volume data of the storage unit 76 a volume data document 82 correspond to the encrypted version, and from the index- resp. reconstruction data of the storage unit 74 an independently running in the framework of an appropriate or suitable runtime environment executable structure description, or script, e.g. JavaScript, XML, VB-Script or like that can be applied independently during the execution on the volume data document 82 and can lead back to the original, unencrypted form.

The four-eye-principle that is described as a development of the present invention—additionally two third parties could decrypt the encrypted document by consecutive applying of their respective single key—which can thereby be implemented, in the described example, in a manner that one third party can decrypt all names and all time data/number data, whereby the second one decrypt the other content components of the document (including the sequence).

In particular within the framework of an internet environment, where the volume data document are already stored locally or on other ways have been lead to the user, can be transferred or transmitted over a secured (and in particular for performing of a suitable, regular access on the document is authorized by identification- and/or payment procedure) script file 84 to the authorized user, and then this can reconstruct the open original version in a comfortable manner (and ideally without ever been confronted with the encrypted volume data document).

Additionally the schematically embodiment shown in FIG. 2 is suitable not only to generate a key file for the storage unit 74 (resp. as executable script file 84), but a plurality, of which ideally however just only one lead to a content-related actually correct result, while other key files as scripts activated decryption procedures, which lead indeed to a meaningful (and therefore seemingly correct) result, but which are not correspond content-related with the original version. Afterwards by this procedure a further increase of the encryption security is provided. It should be immediately understandable, that already small content-related deviations of the (for an user actually worth forming) meaning of the original document can completely destroy its meaning, so that perhaps it needs only small modifications resp. a small number of encryption operations (with the consequence of an corresponding short script files as key data), in order to achieve the designed protection purpose, up to the already mentioned non-encryption of the original file, that only derive their protection purpose from the circumstances, that a person doing an illegally access have the uncertainty, whether he is handling with an open (i.e. the original file with its corresponding) content, or if he is handling with an encrypted, i.e. that is not matching with the original file or content.

The present invention is not limited on the exemplary example of text files. It offers in particular for further electronic document to encrypt in a principally similar described manner, while these electronic document comprise a suitable structure with content components that enable basic operations that encrypt with the interchanging, removing, attaching or exchanging. Typical further applications would be also music files, which are usually existing in so called MP3 format, and wherein it is possible within the framework of the present invention to exchange, to remove or to interchange the data structure (so called frames) given by the MP3 format in a single or block-wise manner (ideally also time-, period - or section-wise, regarding the respective music compositions). Correspondingly this hold for image- and/or video files, because the usual, known document format are based on a sequence of frames as content component (in images or electronic videos these are respective single images), which can be manipulated in a manner according to the invention. So it is here in particular the task of the (related to technical standards) semantic rule-applying unit (FIG. 2), within such complex data structure to discover starting points for an effective manipulation. Correspondingly this apply for color-, contrast-, brightness- or other values also so that it can be used within the framework of a representation- or run-time logic of the appropriate document and which can be changed with the basic operations of the semantic encryption.

1. Data processing apparatus with
a local computer unit which correspond to a local data file system for calling and for storing and for bi-directional data transferring of a volume data file by means of a computer unit
and an user identification unit, which is corresponding to the local computer unit, which enable an access on volume data files through the computer unit by an authorized user as a reaction on its positive identification only,
whereby the volume data file in the local data file system is stored in a encrypted form, which is not usable for a user
characterized in that
a data transferring path of volume data files between the local computer unit and the local data file system comprise a corresponding key management unit as a part and functionality of the local computer unit, which generate and assign at least one user specific and volume data specific key file for each volume data file,
the key management unit with a portion of the local data file system, which is connected to the logically separated key database
and for linking of a key file which is stored in the key database with a volume data file which is stored in a local data file system for generating an electronic document, that is usable by an user
whereby the key database is provided locally in the data processing appliance and assigned to the local data file system, but logical or structural or physical separated from a drive - or mass storage unit.

2. Apparatus as set forth in claim 1, characterized in that the encrypted form comprise the encryption by means of a symmetric key.

3. Apparatus as set forth in claim 1, characterized in that the encrypted form referring of an electronic document as provided on a basis of a volume data file comprise a content - or meaning distorted interchanging, removing or attaching of file components.

4. Apparatus as set forth in claim 1, characterized in that the local data file system is a database and the volume data file is a database register or database records of the database.

5. Apparatus as set forth in claim 1, characterized in that the local data file system is a mass storage unit on a workplace with preferable a plurality of users.

6. Apparatus as set forth in claim 1, characterized in that the volume data files comprise digital text-, program-, image-, sound- and video files and combinations of these.

7. Method for storing and for calling of electronic files, in particular for operating of data processing appliance as set forth in claim 1, characterized by the steps:
identifying of an user who has access to a computer unit and who has access to a volume data files which is stored on a data file system that is assigned to a computer unit;
enabling an authorized access on user specific volume data file as a reaction on a positive identification;
generating of a volume data file and user specific key file for an electronic document that is stored in the data file system and a subsequent linking of the electronic document with the key file for generating and storing of a volume data file, which is not usable for an user;
storing of the generated key file in a key storage unit;
reading of a volume data file and user specific key file as reaction on an access command of an user;
linking of the read-out key file with the volume data file that is given in a non-usable form for an user and that is read-out from the data file system and generating of an usable electronic document.

8. Method for encrypting of an electronically stored original amount of data, in particular a method for generating of a volume data file and user specific key file as set forth in claim 7 whereby the electronically stored original amount of data comprise a sequence of information components of a meta language in form of a written language, of a number system or of information component from data elements that are arranged in a predetermined, unitary format structure, in particular image-, sound- or program information and that are stored in a plurality of electronic addressable storage area, comprising the steps:
Interchanging or removing of an information component in the amount of data or attaching an information component at a predetermined position in the sequence of information components or exchange of an information components with a information component that is preferably not included in the original amount of data by a computer access on the respective storage area for generating of an amount of encrypted data;
generating an amount of key data with information on the interchanged, removed, attached or exchanged information component, which is designed in a manner, that a reconstruction of the original amount of data is permitted and
storing of the amount of encrypted data and storing of the amount of key data in a separated, user specific key file within a common file system.

9. Method for encrypting of an electronically stored original amount of data, in particular a method for operating the key management unit in the apparatus as set forth in claim 1 whereby the electronically stored original amount of data comprise a sequence of information components of a meta language in form of a written language, of a number system or of information component from data elements that are arranged in a predetermined, unitary format structure, in particular image-, sound- or program information and that are stored in a plurality of electronic addressable storage area, comprising the steps:
Interchanging or removing of an information component in the amount of data or attaching an information component at a predetermined position in the sequence of information components or exchange of an information components with a information component that is preferably not included in the original amount of data by a computer access on the respective storage area for generating of an amount of encrypted data;
generating an amount of key data with information on the interchanged, removed, attached or exchanged information component, which is designed in a manner, that a reconstruction of the original amount of data is permitted and
storing of the amount of encrypted data and storing of the amount of key data in a separated, user specific key file within a common file system.

10. Method as set forth in claim 8, characterized in that the successive at least twofold encryption of the amount of key data whereby each is generated with the step of interchanging, removing, attaching or exchanging, whereby a first, hereby generated key data record is assigned to a first user and a second following generated key data record is assigned to a second user.

11. Method as set forth in claim 9, characterized in that the successive at least twofold encryption of the amount of key data whereby each is generated with the step of interchanging, removing, attaching or exchanging, whereby a first, hereby generated key data record is assigned to a first user and a second following generated key data record is assigned to a second user.

12. Apparatus for managing an electronically stored original amount of data, in particular for operating the method as set forth in claim 7 with
an analyzing unit, which is designed to access on the original amount of data which are stored in a document storage unit and which is designed to electronically detect at least a sequence of information components of the original amount of data as a reaction on a predetermined or inspected format- or structural data of the original amount of data,
an encryption unit that is subordinated to the analyzing unit, which is designed for
interchanging or removing of information components in the original amount of data or attaching of an information components at a predetermined position in the sequence of information components or exchanging of an information component with an information component that is preferably not contained in the original amount of data and
creating an amount of key data with information about the interchanged, removed, attached or exchanged information components, which are designed in a manner, that a reconstruction of the original amount is permitted with key data, and
a storage unit which is designed to store the amount of key data in a key data storage unit and
a volume data storage unit, which is designed to store the amount of, encrypted data.

13. Apparatus for managing an electronically stored original amount of data, in particular as part of the key management unit in the apparatus as set forth in claim 1 with
an analyzing unit, which is designed to access on the original amount of data which are stored in a document storage unit and which is designed to electronically detect at least a sequence of information components of the original amount of data as a reaction on a predetermined or inspected format- or structural data of the original amount of data,
an encryption unit that is subordinated to the analyzing unit, which is designed for
interchanging or removing of information components in the original amount of data or attaching of an information components at a predetermined position in the sequence of information components or exchanging of an information component with an information component that is preferably not contained in the original amount of data and
creating an amount of key data with information about the interchanged, removed, attached or exchanged information components, which are designed in a manner, that a reconstruction of the original amount is permitted with key data, and
a storage unit which is designed to store the amount of key data in a key data storage unit and
a volume data storage unit, which is designed to store the amount of, encrypted data.

14. Apparatus as set forth in claim 12, characterized in that the encryption unit is assigned to an equivalence unit, which provide at least one information component in the original amount of data for at least one equivalent information component, that is electronically stored, whereby the equivalent information component is designed in a manner, that it match with the corresponding information component grammatically, metaphorically, syntactically or regarding its format.

15. Apparatus as set forth in claim 14, characterized in that the encryption unit is designed to interconnect with a semantic rule-applying unit, so that the interchanging, removing, attaching or exchanging are arranged within the grammar, format, metaphoric or syntax and which are determined by the format- or structural data.

16. Apparatus as set forth in claim 12, characterized in that a random controller unit is assigned to the encryption unit, in which the interchanging, removing, attaching or exchanging of single information components or sequences of information component are controlled by the encryption unit randomly, in particular in a non reproducible manner.

17. Apparatus as set forth in claim 12, characterized by an encryption parameter unit that is subordinated to the encryption unit, and is designed for storing or inserting predetermined parameter for the interchanging, removing, attaching or exchanging by the encryption unit, in particular regarding a depth of encryption given by a number of interchanging, removing, attaching or exchanging operations.

18. Apparatus as set forth in claim 12, characterized by a conversion unit that is subordinated to the encryption unit, and is designed for generating an electronic transferable volume data file for the amount of encrypted data and preferably an actively executable program- or script file for the amount of key data.

19. Apparatus as set forth in claim 12, characterized in that the encryption unit is designed to generate a plurality of an amount of key data, which comprise at least one of the key data does not provide the reconstruction of the original amount of data while combining with the amount of encrypted data, but which lead to an amount of data after the combining, that is matched with the original amount of data in a syntactically, grammatically or format-related manner.

20. Apparatus as set forth in claim 12, characterized in that the analyzing unit is subordinated to the encryption unit and is designed in a manner that the amount of key data comprise information about the exchanging - or interchanging given by information component used to interchange, remove, attach or exchange.
